(19) United States
(12) Patent Application Publication
(10) Pub. No.: US 2026/0318790 A1
(43) Pub. Date: Oct. 15, 2026

(54) PROCESS

(71) Applicant: INEOS EUROPE AG, Vaud (CH)

(72) Inventors: Philip Van Breuseghem, Temse (BE); Bart Delaet, Buggenhout (BE); Brent Walworth, Sint Niklaas (BE)

(21) Appl. No.: 19/481,369

(22) PCT Filed: Apr. 25, 2024
(86) PCT No.: PCT/EP2024/061378

§ 371 Date: Nov. 4, 2025

(30) Foreign Application Priority Data
May 4, 2023 (EP) 23171662.2

(51) Int. Cl. G01N 1/22; G01N 1/44

(52) U.S. Cl. CPC G01N 1/2247; G01N 1/44; G01N 2001/2267

(57) ABSTRACT

Operation of polymerisation processes, and in particular a process for analysing the liquid phase of a slurry from a reactor for the slurry phase polymerisation of one or more olefins to produce a polyolefin, which process comprises:
a. Polymerising one or more olefins in the reactor to produce a polyolefin in the form of a slurry,
b. Withdrawing slurry from the reactor through one or more product withdrawal lines, the rate of slurry withdrawal in each product withdrawal line being equivalent to at least 5 tonnes/hour.
c. Separately withdrawing a sample of the slurry from the reactor through a sample line,
   wherein the sample of withdrawn slurry is passed from the sample line to a flash vessel to flash the liquid phase to form a gaseous phase and a portion of the gaseous phase is passed to an analyser.

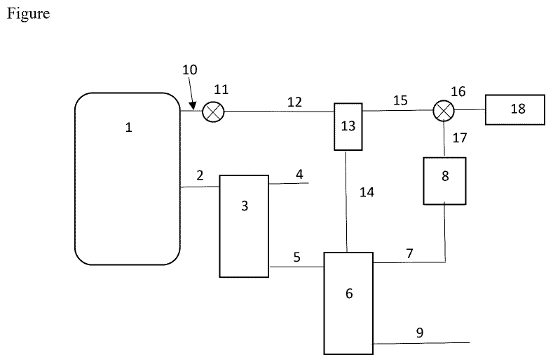

### FIELD AND BACKGROUND OF THE INVENTION

The present invention relates to operation of polymerisation processes, and in particular provides a process for analysing the liquid phase of a slurry withdrawn from a reactor for the polymerisation of olefins to produce a polyolefin.

Polymerisation of olefins to product polyolefins, such as polyethylene and polypropylene products is well known. There are a number of particular production processes which are commercially operated, including gas phase, solution phase and slurry phase processes.

In general, product properties are dependent on the catalyst used and the particular conditions in the polymerisation reactor. The conditions in the reactor include the concentrations of reactants.

Whilst it is relatively easy to measure reactant concentrations in a gas phase process, determining the concentrations in a slurry phase process presents more challenges. In a typical slurry phase process, a slurry of polyolefin solids in a liquid (diluent) phase is withdrawn from the reactor and passed to one or more separation steps to separate the polyolefin solids. The typical separation involves vaporisation of the liquid phase to form a gas phase which can be recycled (usually are cooling and condensing again). The process is often referred to as degassing. Degassing may involve several separation steps, one or more of which may involve use of a purge gas to purge the solids and remove components of the liquid phase.

It is possible to analyse a vaporised gas phase from the “main” polyolefins solids recovery system. However, the most efficient degassing processes involve several stages and often involve purging with a purge gas. Thus, it is difficult to obtain a gas stream for analysis which is representative of the entire liquid phase in the reactor.

For this reason it is also known to provide a dedicated system for recovery of a sample of the slurry for analysis.

U.S. Pat. No. 5,387,659, for example, describes a process in which a separate analysis stream is withdrawn from the reactor and passed to a dedicated low pressure flash vessel to vaporise the liquid phase.

Similarly, WO 2005/080441 describes a process in which a separate analysis stream is withdrawn from the reactor and passed to a dedicated system of one or more flash tanks and one or more sample receivers.

In both of the above documents the amount of slurry withdrawn/sample size is taught to be relatively small. We have now found that it is advantageous to provide a dedicated sample analysis system where there is withdrawn through the sample line/system more slurry than is required solely for the analysis, and in particular that this provides a more stable system which provides highly accurate results.

### SUMMARY OF THE INVENTION

Thus, in a first aspect there is provided a process for analysing the liquid phase of a slurry from a reactor for the slurry phase polymerisation of one or more olefins to produce a polyolefin, which process comprises:
a. Polymerising one or more olefins in the reactor to produce a polyolefin in the form of a slurry,
b. Withdrawing slurry from the reactor through one or more product withdrawal lines, the rate of slurry withdrawal in each product withdrawal line being equivalent to at least 5 tonnes/hour.
c. Separately withdrawing a sample of the slurry from the reactor through a sample line, wherein
   i. The sample line withdraws the slurry from the reactor through a sample line inlet located on the reactor,
   ii. Slurry is withdrawn through a sampling valve on the sample line, wherein the volume, V, of the sample line from the sample line inlet to the valve is less than 0.1 m³,
   iii. Slurry is withdrawn through the sample line at a rate which is equivalent to at least 50 kg/hr but below 5 tonnes/hr,
   wherein the sample of withdrawn slurry is passed from the sample line to a flash vessel to flash the liquid phase to form a gaseous phase and a portion of the gaseous phase is passed to an analyser.

The process of the present invention comprises slurry phase polymerisation of one or more olefins in a reactor to produce a polyolefin in the form of a slurry (i.e. polymer powder suspended in a liquid phase). This may be any suitable slurry phase polymerisation process in any suitable (polymerisation) reactor as known in the art. Particularly preferred processes are processes operated in a slurry loop polymerisation reactor.

The one or more olefins may comprise a single olefin monomer or may comprise a mixture of a first olefin monomer and one or more olefin comonomers, again as is known in the art. Preferably the process is a process comprising polymerisation of ethylene to produce a polyethylene or polymerisation of propylene to produce a polypropylene.

The liquid phase of the slurry phase polymerisation process comprises a diluent, which may be an inert hydrocarbon, such as isobutane, or liquid monomer, such as liquid propylene.

The polymerisation process may use any suitable catalyst, and the slurry may comprise monomers and other reactants, such as hydrogen, which are known in the art.

Typically the reactor is at a pressure of at least 2 MPag, such as in the range 2.5 to 5 MPag, and polymerisation is performed at a temperature of from 60 to 130 °C. (Note that unless specified herein all pressures are gauge pressures.)

The reactor comprises one or more product withdrawal lines for withdrawing slurry from the reactor. Again, this part of the process, which may be considered herein as the “main product withdrawal system”, is generally as known in the art. The withdrawal in the product withdrawal lines may be continuous or discontinuous, for example through one or more settling legs. In the present invention the rate of slurry withdrawal in each product withdrawal line which is present and in use is equivalent to at least 5 tonnes/hour of polyolefin slurry. As used herein this is the total amount of slurry withdrawn in an hour (either continuously or by summing the total amount withdrawn in the discontinuous withdrawals.)

Typically, the withdrawn slurry is heated in one or more flash lines before being passed to a degassing vessel at lower pressure than the reactor. Vaporisation of part, preferably at least 95 wt %, of the liquid phase of the slurry occurs, due to heating and/or due to the pressure reduction, so that there is obtained in the degassing vessel a mixture of polyolefin solids and vaporised gaseous diluent phase.

In preferred embodiments, the degassing vessel is operated at a pressure lower than that in the reactor, but high enough that components of the diluent phase which vaporised and separated can be condensed without compression for recycle. Such is described for example, in WO 2004/26914. (We will for ease of reference, and as is common in the art, use the term “diluent phase” to refer to the liquid phase of the slurry process. It will be apparent that this will actually contain not just the actual diluent but also other reactants such as unreacted olefins and hydrogen.)

Typically the pressure in the degassing vessel is at least 0.5 MPag, preferably from 0.5 MPag to 2 MPag, for example 0.6 MPag to 2 MPag, such as 0.6 MPag to 1.2 MPag. The degassing vessel may be, and typically is, a first degassing vessel which is followed by a second degassing vessel, to which the degassed polyolefin solids from the first degassing vessel are passed, and which operates at a lower pressure. The pressure in the second degassing step may be, for example, 0.01 MPag to 0.4 MPag, such as 0.03 MPag to 0.1 MPag. The treatment in the second degassing step may comprise purging.

In the present invention there is provide a separate sample withdrawal system. In particular withdrawal of a sample of slurry from the reactor takes place by withdrawing a sample of slurry through a sample line and sampling valve to a flash vessel.

The sample line has an inlet (“sample line inlet”), located on the reactor, and a sampling valve on the sample line. The sample line has a volume, V, between the sample line inlet and the sampling valve, which is less than 0.1 m³, and slurry is withdrawn through the sample line at a rate which is equivalent to at least 50 kg/hr but below 5 tonnes/hr. As used herein this rate is the total amount of slurry withdrawn in an hour through the sample line, for example by summing the total amount withdrawn in the discontinuous withdrawals.

In particular, the sample line has a relatively small volume between the sample line inlet and the sampling valve, and a relatively high sample flow rate (slurry withdrawal rate through the line). This ensures that the average volume and average residence time of slurry in the sample line between the reactor and the sampling valve is relatively small, which provides improved accuracy of the sample analysis. (As used herein, the average residence time of the slurry in the sample line is the value obtained by dividing the volume, V, by the average rate of slurry withdrawal.)

In particular, the slurry in the sample line between the reactor and the sampling valve is at high pressure and temperature (due to the reactor pressure and temperature), and comprises catalyst and unreacted monomer. Thus, reaction proceeds in the slurry. However, the slurry is not mixed with fresh feeds as takes place in the reactor. Further the sample line is not efficiently cooled as the reactor is.

Further, where the sampling is performed discontinuously there is a time period between openings of the valve where the slurry is static but polymerisation is continuing in the sample line between the reactor and the sampling valve.

By minimising the sample line volume between the reactor and the sampling valve and taking an increased amount (flow rate) of slurry through the sample line the average residence time of slurry in the sample line between the inlet and the sampling valve is reduced, which minimises the issues with this.

Also, it becomes possible, particularly in a discontinuous process, to withdraw in each withdrawal a volume of slurry which exceeds the volume, V. Thus, even if reaction has occurred in the sample line between the reactor and the sampling valve, the sample withdrawn can be of a volume much higher than V, and any differences between the composition in the volume, V, and the composition in the reactor will be “diluted” and not cause any issue in the subsequent analysis.

Preferably, the volume, V, is less than 0.01 m³, and more preferably less than 0.005 m³.

The volume is determined by the internal diameter of the sample line and the distance between the sample line inlet and the sampling valve. Typically the internal diameter of the sample line, at least between the inlet and the sampling valve is 7.5 cm or less, such as between 1.25 cm and 5 cm. Typically the distance between the sample line inlet and the sampling valve is less than 5 m, and more preferably less than 2 m.

In general, too small a pipe diameter is not preferred since sufficient slurry flow becomes difficult to obtain, whilst physical constraints limit how close the valve can be to the reactor. Typically, therefore, the volume, V, is at least 0.0001 m³.

The slurry is preferably withdrawn through the sample line at a rate which is equivalent to at least 100 kg/hr, for example at least 300 kg/hr.

In general, the higher the overall flow/sampling rate the lower the average residence time in the volume, V, of the sample line. However, larger overall flow rates require larger pipes and downstream vessels, including the flash vessel, and larger recycling systems, which at large flow rates can have limited or no further benefit for the accuracy of the analysis.

Thus, in preferred embodiments, slurry is withdrawn through the sample line at a rate which is less than or equal to 2000 kg/hr, for example at a rate of from 100 to 2000 kg/hr. Slurry is most preferably withdrawn through the sample line at a rate which is less than or equal to 1500 kg/hr, for example at a rate of from 500 to 1500 kg/hr

In preferred embodiments there is provided a single sampling valve on the sample line, such that when the sampling valve is open the sample of the slurry passes directly to the flash vessel. (This can be contrasted, for example, with a system with two valves such as in WO 2005/080441, where the sequence of opening and closing the respective valves slows the rate at which slurry can be withdrawn.)

Whilst it is possible to withdraw the samples continuously in the process of the present invention, preferably the withdrawal of samples of slurry through the sample line is performed discontinuously. For example, the sampling valve may be a valve which can be rotated between a closed position and an open position for a suitable time period to take a sample, and then rotated to a closed position again.

A particularly preferred valve has a single through bore and turns 180 degrees from first closed to second closed position, with an open position in between. This is an improvement compared to two valve system of WO 2005/080441 and in particular is less prone to blockages.

The sample size in a discontinuous withdrawal is determined, for a particular valve size, by the time for which the valve is open and how often this is repeated. Generally, in the present invention the valve may typically be opened for 1 to 5 seconds, 1 to 4 times per minute.

It is preferred that sampling is performed discontinuously where each sample has a slurry mass of 1 to 10 kg, preferably 2 to 5 kg. (It will be apparent that the sample size and the number of times the valve is opened determine the total withdrawal rate. For example to withdraw a total of 500 kg/hr with an individual sample size of 5 kg then the valve must be opened 100 times per hour, etc.)

As noted above, it is preferred that each sample has a volume which is greater than the volume, V to ensure that the sample passing through the valve in each withdrawal samples the reactor and not just the sample line volume, V. Preferably each sample has a volume which is at least 3 times the volume, V, and more preferably at least 5 times the volume, V.

In the present invention the sample of withdrawn slurry is passed from the sample line to a flash vessel to flash the liquid phase to form a gaseous phase, and a portion of the gaseous phase is passed to an analyser.

In preferred embodiments the sample is heated after the sampling valve, either in the sample line between the valve and flash vessel, or in the flash vessel itself, or both. For example, the sample line may have a distance of from 3 to 30 m between the sampling valve and the flash vessel, and the sample line may be heated, for example trace heated.

Further the flash vessel is preferably at a relatively low pressure, and in particular at a pressure below 0.5 MPag, such as in the range 0.01 MPag to 0.5 MPag. In particularly preferred embodiments, as described further below, the flash vessel is connected to a second degassing vessel (the second degassing vessel having already been described above). In such embodiments the pressure in the flash vessel may be similar to that of the second degassing vessel. For example, the pressure in the flash vessel and in the second degassing vessel may both preferably be in the range 0.01 MPag to 0.4 MPag, such as in the range from 0.03 MPag to 0.1 MPag. Most preferably the flash vessel has a pressure which has a pressure differential of less than 10% relative to the pressure in the second degassing vessel.

It may be noted that, in practise, in a discontinuous sampling from the reactor, the pressure in the flash vessel increases with each sample enters into the flash vessel, and then reduces prior to the next sample from the reactor. In such embodiments, and in any other embodiments where the pressure in the flash vessel varies:
(i) The pressure in the flash vessel preferably stays within the “absolute” pressure ranges noted (e.g. below 0.5 MPag, such as in the range 0.01 MPag to 0.5 MPag) throughout, and
(ii) When referring to the pressure being similar to the pressure of a second degassing vessel and/or referring to the pressure differential compared to a second degassing vessel, values of the pressure and pressure differential refer to the pressure of the flash vessel at the minimum pressure during any such variations.

The use of heating and/or low pressure is performed to ensure vaporisation of essentially all of the slurry liquid. A particular advantage of having a separate flash vessel for the sample line is that the pressure can be lower than that which is optimal for a first degassing vessel on the product withdrawal line, so that components of the slurry liquid can be efficiently separated and passed to the analyser. (For avoidance of doubt, one or more of any degassing vessels on the product withdrawal system may also be considered as a flash vessel, whilst the flash vessel on the sample line may be considered as a degassing vessel. For ease of reference in the present invention we will however use the term “flash vessel” to refer to the flash vessel connected to the sample line, and the term “degassing vessel” for any vessels on the product withdrawal line.)

In preferred embodiments the solids separated in the flash vessel are subsequently combined with polyolefin solids recovered via the one or more product withdrawal lines. The solids can then be recovered as a commercial product with the solids withdrawn through the main product withdrawal line or lines.

In a preferred option, where first and second degassing vessels are present on the product withdrawal system then the flash vessel may be connected to the second degassing vessel, and solids from the flash vessel be passed to the second degassing vessel. The solids can then be recovered therefrom with the solids recovered via the main product withdrawal lines.

In the present invention a portion of the gaseous phase from the flash vessel formed by vaporising the liquid phase is passed to an analyser. Any analyser suitable for analysis of the composition of the gaseous phase may be used. A Gas Chromatograph (GC) is preferred.

In the present invention it is preferred that samples are withdrawn through the sample line/sampling valve at a frequency (sampling frequency) higher than the frequency at which samples are passed to the analyser.

In particular, typically a portion of gaseous phase may be injected into the GC once every few minutes, such as once every 2-10 minutes. However, the sampling frequency from the reactor (the number of times per minute the valve is opened) is preferably 1 to 4 times per minute as already described above. The faster sampling frequency from the reactor is advantageous, as already noted, in ensuring that slurry does not sit in the sample line between the inlet and the sampling valve for too long. In contrast, if the sampling frequency correlated to the GC injection frequency, the sample would sit in the sample line for several minutes each time.

In a preferred embodiment, there is connected to the flash vessel a gas circuit for the analyser. Gas is passed, for example pumped, continuously from the flash vessel into the gas circuit. When an analysis is needed, gas is provided e.g. injected, from this circuit to the analyser. A continuous supply of gas to the circuit can be achieved by selecting a sampling rate from the reactor through the sample line/sampling valve which is such as to maintain a total flow of slurry from the reactor which can provide sufficient gas in the flash vessel to continuously feed the gas circuit.

One or more filters may be provided to prevent solids passing to the analyser. Typically a filter is provided on the outlet of the flash vessel by which the gaseous phase which is to be passed to the analyser exits the flash vessel, whether this feeds to the analyser directly or via a gas circuit as described. Typically a filter is provided at the inlet of the analyser, independently of whether a filter is also provided on the flash vessel prior to this.

Any gas not passed to the analyser from the gas circuit or from the flash vessel may be recycled to the reactor, for example via existing recycle systems for gas recovered in the main product withdrawal system. For example, gas not passed from the flash vessel to the gas circuit may pass to the second degassing vessel with the polyolefins. Gas from the gas circuit which is not passed to the analyser may also be passed to the second degassing vessel or to systems which treat the gas recovered from the second degassing vessel.

In most preferred embodiments, the reactor is a slurry loop polymerisation reactor where the slurry loop polymerisation reactor has 2n vertical sections,, n being at least 1, each vertical section each being connected at its upper end (for example via an upper 180 degree elbow (bend) or via an upper horizontal section and two 90 degree elbows) to the upper end of another vertical section, and connected at its lower end (for example via a lower 180 degree elbow (bend) or via a lower horizontal section and two 90 degree elbows) to the lower end of another vertical section, the entirety forming a continuous loop.

For example, a vertically orientated loop reactor may have 2, 4, 6, 8, 10 or 12 vertical legs, joined by 180 degree elbows or by (generally shorter) horizontal sections and 90 degree elbows joining the tops and bottoms of adjacent legs, as known in the art.

In such a slurry loop polymerisation reactor the sample line inlet is preferably located on the inside of an elbow, preferably an elbow at the top of the reactor, or on the inside side of the reactor and within 3 m distance of a reactor elbow on the upper part by height of the reactor i.e. on the inside at the top part of a vertical leg or on the bottom of a horizontal leg.

(As used herein “inside side of the reactor” means on the inside half of the circumference of the reactor, the inside being defined as the inside of the reactor at the nearest elbow.)

An advantage of such a location is that the loop reactor may have a significant height e.g. the vertical legs may be 20 m or more in length, so having a “high” sample line inlet location allows the pipe from the sampling valve to the flash vessel to be downwardly orientated, such as vertical, in the direction of flow (i.e. from the sampling valve to the vessel). This can provide gravity assistance to flow. The height can also allow the flash vessel to be located higher than, such as above, any downstream vessel to which the solids are sent, again to provide gravity assistance to the flow.

In some embodiments the sample line inlet can be located after the elbow in the direction of flow. This location provides a sample with relatively low solids content compared to the average solids content in the reactor, which reduces the risk of blockage in the sample line.

The results from the analyser provide the composition of the diluent phase in the reactor, including concentrations of monomer, comonomer and other reactants. This information can be used as basis to adjust the concentrations if desired.

In embodiments, there may be provided two or more sample lines on a single reactor. For example, it may be desired to sample the reactor on different sections. This is particularly the case on large loop reactors where the reactor length can be significant and potentially large differences in concentrations may be found at different sections of the reactor. In such situations, typically each sample line will have a dedicated flash vessel. Each line may also have its own (i.e. dedicated) analyser, although this is not essential, and in some embodiments a common analyser may be used for samples from two or more sample lines.

### BRIEF DESCRIPTION OF THE DRAWING

The Figure is a schematic representation of the process.

### DETAILED DESCRIPTION OF THE INVENTION

A preferred embodiment of the present invention is represented in schematic form in the Figure. In particular, the Figure shows a loop reactor (1) in which slurry phase polymerisation of olefins takes place to produce polyolefin in the form of a slurry which circulates in the reactor. Slurry is withdrawn from the reactor through one or more product withdrawal lines, represented schematically by (2) in the Figure, and passed to a first degassing vessel (3). Vaporised diluent from the slurry is recovered from the first degassing vessel (3) via line (4) and recovered for recycle (not shown) to the reactor (1), whilst polyolefin solids and remaining diluent are passed via line (5) to a second degassing vessel (6).

Further diluent is separated from the polyolefin in the second degassing vessel (6), recovered from the second degassing vessel (6) via line (7) and passed to further processing, represented schematically by (8) in the Figure. Polyolefin solids from the second degassing vessel are recovered via line (9). The polyolefin solids may be passed to storage or to further treatment, such as extrusion (not shown).

Separately a sample of the slurry from the reactor (1) is withdrawn through a sample line (10, 12) having a sampling valve (11). The volume, V, of the sample line from the sample line inlet to the valve (11), is represented by section (10) in the Figure, and is less than 0.1 m³.

The sample of withdrawn slurry is passed from the sampling valve (11) to a flash vessel (13). In the flash vessel (13) the slurry is vaporised to produce a gaseous phase. A portion of the gaseous phase is passed to a gas circuit (15, 17) comprising an injection valve (16), whilst polyolefin solids and remaining gaseous phase are passed via line (14) to the second degassing vessel (6). A continuous flow of the gaseous phase normally passes through line (15), valve (16) and line (17) to further processing (8). Periodically, the valve 16 is switched so as to inject a portion of the gaseous phase into an analyser (18).

### Example

The present Example illustrates a process according to the present invention. Ethylene is polymerised in the presence of isobutane diluent and a polymerisation catalyst in a slurry loop polymerisation system comprising two slurry loop polymerisation reactors in series, to produce a high density polyethylene (HDPE). Reaction is performed at about 4 MPag.

A slurry stream comprising HDPE and diluent is withdrawn continuously from the second polymerization reactor at a rate of 42000 kg/hr of HDPE and 53000 kg/hr of diluent phase. The slurry stream is depressurised and heated, and then passed into degassing system comprising a first degassing vessel operating at a pressure of 0.8 MPag and a second degassing vessel operated at a pressure of 0.03 MPag. In the first degassing vessel degassing occurs with separation of vaporised diluent phase, including unreacted olefin monomers, from the HDPE solids, and with the majority of the vaporised phase discharged from the top of the first degassing vessel. The HDPE and the remaining part of the vaporised diluent phase is passed to a second degassing vessel where separation of the remaining diluent takes place.

A sample line is connected to the first reactor via a sample line inlet on the inside of an elbow at the top of a vertical leg where the slurry flow turns vertically downwards i.e. on an elbow at the top of a leg in which the flow is downwards. The sample inlet line has an internal diameter of 2.5 cm, and a length of 0.8 m prior to a 2.5 cm sampling valve, giving a volume, V, of 0.00039 m³.

After the sampling valve the sample line connects to a flash vessel having a diameter of 325 mm and a total volume of 0.13 m³. The flash vessel operates at a minimum pressure (the pressure just before each sample is taken) which is the same as the pressure in the second degassing vessel i.e. 0.03 MPag. The line from the sampling valve to the flash vessel has an internal diameter of 5 cm and a length of 20 m, and is heated to vaporise the diluent phase of the slurry.

Slurry is withdrawn from the reactor through the sample line by opening the sampling valve for 3 seconds twice per minute (The “opening” time is defined as the time taken from when the sampling valve is first moved from its closed position to when it is back to a closed position). Each sample is approximately 7.5 kg of slurry, giving a total withdrawal rate of 900 kg/hr. Each sample comprises approximately 35 wt % polyolefin solids (and 65 wt % diluent.

A gas circuit connects the headspace of the flash vessel to a GC analyser. A gas sample is injected to the GC once every 4 minutes. The results of the analysis are used to control the concentrations of the reactants in the second reactor.

The polyolefin solids are recovered from the flash vessel and passed to the second degassing vessel.

1. A process for analysing a liquid phase of a slurry from a reactor for polymerisation of olefins to produce a polyolefin, which process comprises:
a. polymerising olefins in the reactor to produce a polyolefin in the form of a slurry,
b. withdrawing the slurry from the reactor through at least one product withdrawal line, a rate of slurry withdrawal in each of the at least one product withdrawal lines being equivalent to at least 5 tonnes/hour, and
c. separately withdrawing a sample of the slurry from the reactor through a sample line, wherein
i. the sample line withdraws the slurry from the reactor through a sample line inlet located on the reactor,
ii. the slurry is withdrawn through a sampling valve on the sample line, wherein a volume, V, of the sample line from the sample line inlet to the sampling valve is less than 0.1 m³,
iii. the slurry is withdrawn through the sample line at a rate which is equivalent to at least 50 kg/hr but below 5 tonnes/hr,
wherein the sample of withdrawn slurry is passed from the sample line to a flash vessel to flash the liquid phase to form a gaseous phase and a portion of the gaseous phase is passed to an analyser.

2. The process according to claim 1 wherein the volume, V, of the sample line from the sample line inlet to the sampling valve is less than 0.01 m³.

3. The process according to claim 1 wherein the slurry is withdrawn through the sample line at a rate which is equivalent to at least 100 kg/hr.

4. The process according to claim 1 wherein the slurry is withdrawn through the sample line at a rate which is less than or equal to 2000 kg/hr.

5. The process according to claim 1 wherein there is provided a single sampling valve on the sample line, such that when the sampling valve is open the sample of the slurry passes directly to the flash vessel.

6. The process according to claim 1 wherein a plurality of the samples of slurry withdrawn through the sample line are withdrawn discontinuously.

7. The process according to claim 6 where each of the plurality of samples has a slurry mass of 1 to 10 kg.

8. The process according to claim 6 wherein each of the plurality of samples has a volume which is greater than the volume, V.

9. The process according to claim 6 wherein the plurality of samples are taken at a frequency (sampling frequency) higher than a frequency at which the analyser operates.

10. The process according to claim 6 wherein there is provided a gas circuit by which gas from the flash vessel is passed to the analyser and the gas circuit is fed continuously with gas from the flash vessel, and the a sampling rate is such as to maintain a total flow of the slurry from the reactor which can provide sufficient gas in the flash vessel to continuously feed the gas circuit.

11. The process according to claim 1 wherein the sample is heated in the sample line after the sampling valve and/or in the flash vessel.

12. The process according to claim 1 wherein the reactor is at a pressure of at least 2 MPag and the flash vessel is at a pressure of less than 0.5 MPag.

13. The process according to claim 1 wherein solids from the flash vessel are passed to a downstream degassing vessel which is at a lower pressure than a minimum pressure in the flash vessel.

14. The process according to claim 1 wherein the reactor is a slurry loop reactor having 2n vertical sections, n being at least 1, each vertical section being connected at its upper end to an upper end of another vertical section, and connected at its lower end to a lower end of another vertical section, an entirety of the vertical sections and connections forming a continuous loop.

15. The process according to claim 1 wherein the sample line inlet is located on an inside side of the reactor and within 3 m distance of a reactor elbow on an upper part by height of the reactor.

16. The process according to claim 6 wherein the sample is heated in the sample line after the sampling valve and/or in the flash vessel.

17. The process according to claim 6 wherein the reactor is at a pressure of at least 2 MPag and the flash vessel is at a pressure of less than 0.5 MPag.

18. The process according to claim 6 wherein solids from the flash vessel are passed to a downstream degassing vessel which is at a lower pressure than a minimum pressure in the flash vessel.

19. The process according to claim 6 wherein the reactor is a slurry loop reactor having 2n vertical sections, n being at least 1, each vertical section being connected at an upper end to an upper end of another vertical section, and connected at a lower end to a lower end of another vertical section, an entirety of the vertical sections and connections forming a continuous loop.

20. The process according to claim 6 wherein the sample line inlet is located on an inside side of the reactor and within 3 m distance of a reactor elbow on an upper part by height of the reactor.
